(19) United States
(12) Patent Application Publication
(10) Pub. No.: US 2026/0070789 A1
(43) Pub. Date: Mar. 12, 2026

(54) METHOD FOR SYNTHESIZING LITHIUM IRON PHOSPHATE USING ANHYDROUS AMORPHOUS IRON PHOSPHATE

(71) Applicant: Sichuan Jinhengfengling New Material Technology Co., Ltd., Mianyang City (CN)

(72) Inventors: Wei ZHANG, Mianyang City (CN); Xiaohui LIU, Mianyang City (CN); Lin CHEN, Mianyang City (CN)

(21) Appl. No.: 19/013,611

(22) Filed: Jan. 8, 2025

(30) Foreign Application Priority Data
Sep. 10, 2024 (CN) 202411261383.8

(51) Int. Cl. C01B 25/45; H01M 4/58

(52) U.S. Cl. CPC C01B 25/45; H01M 4/5825; C01P 2004/61; C01P 2006/40

(57) ABSTRACT

Disclosed is a method for synthesizing lithium iron phosphate using anhydrous amorphous iron phosphate. The method includes the following steps: mixing an anhydrous amorphous iron phosphate, a lithium source, an organic carbon source, and a liquid alcohol to obtain a wet mixture; grinding the wet mixture to obtain a slurry, and subjecting the slurry to spray drying to obtain a lithium iron phosphate precursor powder; and calcining the lithium iron phosphate precursor powder in a protective gas atmosphere to obtain an olivine lithium iron phosphate. An anhydrous amorphous iron phosphate is used as a raw material.

### CROSS REFERENCE TO RELATED APPLICATION

This patent application claims the benefit and priority of Chinese Patent Application No. 2024112613838 filed with the China National Intellectual Property Administration on Sep. 10, 2024, the disclosure of which is incorporated by reference herein in its entirety as part of the present application.

### TECHNICAL FIELD

The present disclosure belongs to the technical field of preparation of lithium iron phosphate, and in particular relates to a method for synthesizing lithium iron phosphate using anhydrous amorphous iron phosphate.

### BACKGROUND

Lithium iron phosphate has attracted much attention as a new generation of positive electrode material for lithium batteries. With the development of the lithium battery industry, lithium iron phosphate positive electrode materials are considered a new generation of lithium-ion positive electrode materials due to their advantages of safety, nontoxicity, environmental friendliness, and high specific capacity.

Currently, lithium iron phosphate is generally synthesized by mixing an olivine iron phosphate with a lithium source and a carbon source in deionized water, and subjecting a resulting mixture to grinding, spray drying and roasting in sequence to obtain an olivine lithium iron phosphate positive electrode material. A drawback of this method is that several hours of roasting in a rotary kiln at a temperature of 600° C. to 700° C. is required to obtain the olivine iron phosphate. Therefore, on the one hand, this method is energy-intensive, and on the other hand, magnetic impurities are inevitably introduced into the materials due to frictions between materials and walls of the rotary kiln. Such magnetic impurities are difficult to completely remove in the subsequent process, thus affecting the quality of the lithium iron phosphate positive electrode materials.

### SUMMARY

An object of the present disclosure is to provide a method for synthesizing lithium iron phosphate using anhydrous amorphous iron phosphate. The method according to the present disclosure not only can improve the quality of a lithium iron phosphate positive electrode material, but also can reduce energy consumption during the synthesis process, and is suitable for industrial production.

In order to achieve the object described above, the present disclosure provides the following technical solutions.

The present disclosure provides a method for synthesizing lithium iron phosphate using anhydrous amorphous iron phosphate, including the following steps:
mixing the anhydrous amorphous iron phosphate, a lithium source, an organic carbon /8778source, and a liquid alcohol to obtain a wet mixture;
grinding the wet mixture to obtain a slurry, and subjecting the slurry to spray drying to obtain a lithium iron phosphate precursor powder; and
calcining the lithium iron phosphate precursor powder in a protective gas atmosphere to obtain an olivine lithium iron phosphate.

In some embodiments, the lithium source includes at least one selected from the group consisting of lithium carbonate lithium hydroxide.

In some embodiments, a molar ratio of iron ions in the anhydrous amorphous iron phosphate to lithium ions in the lithium source is 1:1.

In some embodiments, the organic carbon source includes at least one selected from the group consisting of glucose and sucrose.

In some embodiments, a mass of the organic carbon source accounts for 10% to 20% of a total mass of the anhydrous amorphous iron phosphate and the lithium source.

In some embodiments, the liquid alcohol includes a liquid fatty alcohol and/or a liquid aromatic alcohol; the liquid fatty alcohol includes at least one selected from the group consisting of methanol, ethanol, propanol, ethylene glycol, and glycerol; and the liquid aromatic alcohol includes benzyl alcohol and phenylethyl alcohol.

In some embodiments, a mass of the liquid alcohol accounts for 120% to 150% of a total mass of the anhydrous amorphous iron phosphate, the lithium source, and the organic carbon source.

In some embodiments, the grinding is conducted for 3 h to 5 h to obtain the slurry, and the slurry is subjected to spray drying; and the slurry has a particle size D₅₀ of 0.4 μm to 0.5 μm.

In some embodiments, the spray drying is conducted at a rotational speed of 10,000 rpm to 15,000 rpm; and the lithium iron phosphate precursor powder has a particle size of 35 μm to 40 μm.

In some embodiments, the calcinating is conducted at a calcination temperature of 600° C. to 900° C., and holding at the calcination temperature lasts for 8 h to 10 h; a heating rate of heating the lithium iron phosphate precursor powder from room temperature to the calcination temperature is in a range of 1° C./min to 10° C./min; and the calcination is conducted in a tunnel kiln.

The present disclosure provides a method for synthesizing lithium iron phosphate using anhydrous amorphous iron phosphate, including the following steps: mixing an anhydrous amorphous iron phosphate, a lithium source, an organic carbon source, and a liquid alcohol to obtain a wet mixture; grinding the wet mixture to obtain a slurry, and subjecting the slurry to spray drying to obtain a lithium iron phosphate precursor powder; and calcining the lithium iron phosphate precursor powder in a protective gas atmosphere to obtain an olivine lithium iron phosphate. Compared with the prior art, the embodiments of the present disclosure at least have the following beneficial effects:
1. In the present disclosure, anhydrous amorphous iron phosphate is used as a raw material. Since anhydrous amorphous iron phosphate is amorphous and has a very small particle size. Therefore, it is easily mixed fully with a lithium source, an organic carbon source, and a liquid alcohol, such that after subsequent roasting, a lithium iron phosphate positive electrode material sufficiently embedded with lithium can be obtained, thus improving the energy density of the positive electrode material.
2. In the present disclosure, anhydrous amorphous iron phosphate is used as a raw material, without the need for a pre-treatment step of roasting in a rotary kiln, such that the introduction of magnetic foreign bodies is effectively reduced, thus improving the quality of the lithium iron phosphate positive electrode material and the safety performance of the lithium iron phosphate battery.
3. In the present disclosure, anhydrous amorphous iron phosphate is used as a raw material. Since the raw material does not contain crystal water, it is unnecessary to perform the pre-treatment step of roasting in a rotary kiln, such that the energy consumption during the synthesis of lithium iron phosphate positive electrode materials can be effectively reduced.

### DETAILED DESCRIPTION OF THE EMBODIMENTS

The present disclosure provides a method for synthesizing lithium iron phosphate using anhydrous amorphous iron phosphate, including the following steps:
mixing an anhydrous amorphous iron phosphate, a lithium source, an organic carbon source, and a liquid alcohol to obtain a wet mixture;
grinding the wet mixture to obtain a slurry, and subjecting the slurry to spray drying to obtain a lithium iron phosphate precursor powder; and calcining the lithium iron phosphate precursor powder in a protective gas atmosphere to obtain an olivine lithium iron phosphate.

In the present disclosure, unless otherwise specified, all the raw materials/components used for the preparation are commercially available products well-known to those skilled in the art.

In the present disclosure, the anhydrous amorphous iron phosphate, a lithium source, an organic carbon source, and a liquid alcohol are mixed to obtain a wet mixture. In the present disclosure, the anhydrous amorphous iron phosphate refers to FePO₄ that does not contain crystal water and does not exhibit any crystal form (amorphous). In the present disclosure, there is no special requirements on the source of the anhydrous amorphous iron phosphate, and the anhydrous amorphous iron phosphate may be any commercially available products. In some embodiments of the present disclosure, the lithium source includes lithium carbonate and/or lithium hydroxide. In some embodiments, a mass ratio of the anhydrous amorphous iron phosphate to the lithium source is based on a molar ratio of iron ions of the anhydrous amorphous iron phosphate to lithium ions of the lithium source being 1:1. In some embodiments, the organic carbon source includes glucose and/or sucrose. A mass of the organic carbon source accounts for preferably 10% to 20%, and more preferably 13% to 15% of a total mass of the anhydrous amorphous iron phosphate and the lithium source. In some embodiments of the present disclosure, the liquid alcohol refers to an organic alcohol compound in a liquid state at atmospheric temperature and atmospheric pressure. In some embodiments, the liquid alcohol includes a liquid fatty alcohol and/or a liquid aromatic alcohol; in some embodiments, the liquid fatty alcohol includes at least one selected form the group consisting of methanol, ethanol, propanol, ethylene glycol, and glycerol. The liquid aromatic alcohol preferably includes benzyl alcohol and/or phenylethyl alcohol. The liquid alcohol is more preferably methanol or ethanol. In some embodiments, a mass of the liquid alcohol accounts for 120% to 150% of a total mass of the anhydrous amorphous iron phosphate, the lithium source, and the organic carbon source. In some embodiments, the mixing includes the following steps: mixing anhydrous amorphous iron phosphate and a lithium source, and then sequentially adding an organic carbon source and a liquid alcohol for mixing. In the present disclosure, there is no special requirements on the specific method of the mixing.

In the present disclosure, a resulting wet mix is subjected to grinding and then spray drying to obtain the lithium iron phosphate precursor powder. In the present disclosure, the grinding is conducted for preferably 3h to 5 h, more preferably 3 h to 3.5 h to obtain a slurry. In the present disclosure, the slurry is subjected to spray drying. In some embodiments, the slurry has a particle size D₅₀ of 0.4 μm to 0.5 μm, and the slurry obtained in embodiments has a particle size D₅₀ of 0.43 μm or 0.45 μm. In some embodiments, the spray drying is conducted at a rotational speed of 10,000 rpm to 15,000 rpm, and the rotational speed is the rotational speed of a spray atomizer wheel during spray-drying. In some embodiments, the lithium iron phosphate precursor powder has a particle size of 35 μm to 40 μm. The lithium iron phosphate precursor powder obtained in the embodiments has a particle size of 37.1 μm or 36.8 μm. In some embodiments of the present disclosure, the liquid alcohol in the slurry is removed by spray drying.

In the present disclosure, the lithium iron phosphate precursor powder is calcined in a protective gas atmosphere to obtain an olivine lithium iron phosphate. In some embodiments of the present disclosure, the calcining is conducted at a calcination temperature of 600° C. to 900° C., and holding at the calcination temperature lasts for 8 h to 10 h. In an embodiment of the present disclosure, the calcination is conducted at the calcination temperature of 750° C. and holding at the calcination temperature lasts for 8.5 h or 9 h. A heating rate of heating the lithium iron phosphate precursor powder from room temperature to the calcination temperature is preferably 1° C. /min to 10° C. /min; and more preferably 5° C. /min to 10° C. /min. In some embodiments, the protective gas during the calcining is provided by nitrogen. In some embodiments, the calcining is conducted in a tunnel kiln.

In some embodiments of the present disclosure, the method further comprises subjecting the olivine lithium iron phosphate is to crushing and sieving in sequence to obtain a finished olivine lithium iron phosphate product. In the present disclosure, there is no special requirements on specific methods of the crushing and sieving.

To further illustrate the present disclosure, the technical solutions provided by the present disclosure will be described in detail below in conjunction with examples, which cannot be construed as limiting the scope of the present disclosure, however.

### Example 1

Lithium carbonate and anhydrous amorphous iron phosphate were mixed at a molar ratio of lithium ions to iron ions of 1:1. 13% by mass of sucrose accounting for the total mass of lithium carbonate and anhydrous amorphous iron phosphate was added for mixing. 120% by mass of ethanol accounting for the total mass of the materials (lithium carbonate, anhydrous amorphous iron phosphate, and sucrose) was added for mixing to be uniform. A resulting mixture was then ground for 3 h to obtain a slurry with a measured particle size D₅₀=0.46 μm. The slurry was subjected to spray drying at the rotational speed of a spray atomizer wheel being 14,316 rpm to obtain a lithium iron phosphate precursor powder with a particle size of 37.1 μm. The sprayed lithium iron phosphate precursor with a large spray particle size was heated to 750° C. at a heating rate of 5° C. /min, and held at the 750° C. for 8.5 h under nitrogen atmosphere to obtain a sintered lithium iron phosphate. The sintered lithium iron phosphate was crushed and sieved to obtain a finally finished lithium iron phosphate product.

### Example 2

Lithium hydroxide and anhydrous amorphous iron phosphate were mixed at a molar ratio of lithium ions to iron ions of 1:1. 15% by mass of glucose accounting for the total mass of lithium carbonate and anhydrous amorphous iron phosphate was added for mixing. 120% by mass of methanol accounting for the total mass of the materials (lithium carbonate, anhydrous amorphous iron phosphate, and sucrose) was added for mixing to be uniform. A resulting mixture was then ground for 3.5 h to obtain a slurry with a measured particle size D₅₀=0.43 μm. The resulting slurry was subjected to spray drying at the rotational speed of a spray atomizer wheel being 14,115 rpm to obtain a lithium iron phosphate precursor powder with a particle size of 36.8 μm. The sprayed lithium iron phosphate precursor with a large spray particle size was heated to 750° C. at a heating rate of 10° C. /min, and at the 750° C. for 9 h under nitrogen atmosphere to obtain a sintered lithium iron phosphate. The sintered lithium iron phosphate was crushed and sieved to obtain a finally finished lithium iron phosphate product.

As can be seen from the examples described above, since anhydrous amorphous iron phosphate particles of the method according to the present disclosure are very small, they are easily mixed fully with a lithium source (lithium carbonate or lithium hydroxide), an organic carbon source (glucose or sucrose), and a liquid alcohol (methanol or ethanol), such that after subsequent roasting, a lithium iron phosphate positive electrode material sufficiently embedded with lithium can be obtained, thus improving the energy density of the positive electrode material. Moreover, the method according to the present disclosure effectively reduces the introduction of magnetic foreign bodies, thus improving the quality of the lithium iron phosphate positive electrode materials and the safety performance of the lithium iron phosphate battery. In addition, the energy consumption during the synthesis of lithium iron phosphate positive electrode materials can also be effectively reduced.

Although the examples described above have provided a detailed description of the present disclosure, they are only a part of, rather than all of the embodiments of the present disclosure. Other embodiments that can be obtained according to the embodiments of the present disclosure without creative efforts shall fall within the scope of the disclosure.

What is claimed is:

1. A method for synthesizing lithium iron phosphate using anhydrous amorphous iron phosphate, comprising the following steps:
mixing the anhydrous amorphous iron phosphate, a lithium source, an organic carbon source, and a liquid alcohol to obtain a wet mixture;
grinding the wet mixture to obtain a slurry, and subjecting the slurry to spray drying to obtain a lithium iron phosphate precursor powder; and
calcining the lithium iron phosphate precursor powder in a protective gas atmosphere to obtain an olivine lithium iron phosphate.

2. The method according to claim 1, wherein the lithium source comprises at least one selected from the group consisting of lithium carbonate and lithium hydroxide.

3. The method according to claim 1, wherein a molar ratio of iron ions in the anhydrous amorphous iron phosphate to lithium ions in the lithium source is 1:1.

4. The method according to claim 2, wherein a molar ratio of iron ions in the anhydrous amorphous iron phosphate to lithium ions in the lithium source is 1:1.

5. The method according to claim 1, wherein the organic carbon source comprises at least one selected from the group consisting of glucose and sucrose.

6. The method according to claim 1, wherein a mass of the organic carbon source accounts for 10% to 20% of a total mass of the anhydrous amorphous iron phosphate and the lithium source.

7. The method according to claim 5, wherein a mass of the organic carbon source accounts for 10% to 20% of a total mass of the anhydrous amorphous iron phosphate and the lithium source.

8. The method according to claim 1, wherein the liquid alcohol comprises at least one selected from the group consisting of a liquid fatty alcohol and a liquid aromatic alcohol; the liquid fatty alcohol comprises at least one selected from the group consisting of methanol, ethanol, propanol, ethylene glycol, and glycerol; and the liquid aromatic alcohol comprises at least one selected from the group consisting of benzyl alcohol and phenylethyl alcohol.

9. The method according to claim 1, wherein a mass of the liquid alcohol accounts for 120% to 150% of a total mass of the anhydrous amorphous iron phosphate, the lithium source, and the organic carbon source.

10. The method according to claim 8, wherein a mass of the liquid alcohol accounts for 120% to 150% of a total mass of the anhydrous amorphous iron phosphate, the lithium source, and the organic carbon source.

11. The method according to claim 1, wherein the grinding is conducted for 3 h to 5 h to obtain the slurry, and the slurry is subjected to spray drying; and the slurry has a particle size D₅₀ of 0.4 μm to 0.5 μm.

12. The method according to claim 1, wherein the spray drying is conducted at a rotational speed of 10,000 rpm to 15,000 rpm; and the lithium iron phosphate precursor powder has a particle size of 35 μm to 40 μm.

13. The method according to claim 1, wherein the calcining is conducted at a calcination temperature of 600° C. to 900° C., and holding at the calcination temperature lasts for 8 h to 10 h;
a heating rate of heating the lithium iron phosphate precursor powder from room temperature to the calcination temperature is in a range of 1° C./min to 10° C./min; and
the calcining is conducted in a tunnel kiln.

14. The method according to claim 12, wherein the calcining is conducted at a calcination temperature of 600° C. to 900° C., and holding at the calcination temperature lasts for 8 h to 10 h;
a heating rate of heating the lithium iron phosphate precursor powder from room temperature to the calcination temperature is in a range of 1° C./min to 10° C./min; and
the calcining is conducted in a tunnel kiln.
